(19) United States
(12) Patent Application Publication
(10) Pub. No.: US 2013/0272373 A1
(43) Pub. Date: Oct. 17, 2013

(54) VIDEO ENCODER WITH 2-BIN PER CLOCK CABAC ENCODING

(71) Applicants: Samuel Wong, Santa Clara, CA (US); Hiu-Fai R. Chan, Rancho Cordova, CA (US); Mohmad I. Qurashi, Orangevale, CA (US)

(72) Inventors: Samuel Wong, Santa Clara, CA (US); Hiu-Fai R. Chan, Rancho Cordova, CA (US); Mohmad I. Qurashi, Orangevale, CA (US)

(73) Assignee: INTEL CORPORATION, Santa Clara, CA (US)

(21) Appl. No.: 13/977,078

(22) PCT Filed: Nov. 15, 2011
(86) PCT No.: PCT/US2011/060779

§ 371 Date: Jun. 28, 2013

(51) Int. Cl. H04N 7/26

(52) U.S. Cl. CPC H04N 19/00
USPC 375/240.01

(57) ABSTRACT

Systems, devices and methods are described including using, during a single clock cycle, one Context-Based Adaptive Arithmetic Coding (CABAC) engine to encode one bin value and another CABAC engine to encode another bin value. The probability state index of each CABAC engine may provided to the other CABAC engine when the bin values are encoded.

### BACKGROUND

In the Advanced Video Coding (AVC) encoder pipeline, macroblock video data is represented by syntax elements. Typically, syntax elements are subjected to a binarization process and are then encoded using a Context-Based Adaptive Arithmetic Coding (CABAC) engine. The CABAC encoding process is based on a recursive interval subdivision scheme. A conventional CABAC engine encodes only one bit or “bin” of a binarized syntax element during any given clock cycle.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may he exaggerated relative to other elements for clarity. Further, where considered appropriate, reference labels have been repeated among the figures to indicate corresponding or analogous elements. In the figures:

FIG. 1 is an illustrative diagram of an example video encoder system;

FIG. 2 illustrates the entropy encoding module of FIG. 1;

FIG. 3 illustrates an example process;

FIG. 4 illustrates the entropy encoding module of FIG. 2 in greater detail;

FIG. 5 illustrates a portion of the entropy encoding module of FIG. 4 in greater detail; and

FIG. 6 is an illustrative diagram of an example computing system, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and max implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media: flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation or embodiment. Further, when a particular feature, structure, or characteristic is described in connection with an implementation, it is submitted that it is within the knowledge of one skilled in the art to effect such feature, structure, or characteristic in connection with other implementations whether or not explicitly described herein.

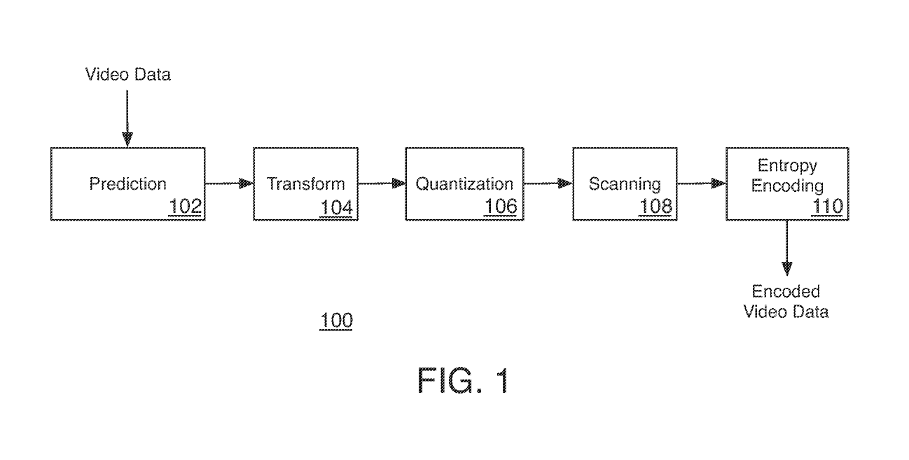

FIG. 1 illustrates a high-level block diagram of an example video encoder 100 in accordance with the present disclosure. In various implementations, encoder 100 may include a prediction module 102, a transform module 104, a quantization module 106, a scanning module 108, and, an entropy encoding module 110, In various implementations, encoder 100 may be configured to encode video data (e.g., in the form of video frames or pictures) according to various video coding standards and/or specifications, including, but not limited to, the H.264/Advanced Video Coding (AVC) standard (see, e.g., Joint Video Team of ITU-T and ISO/IEC JTC 1, “Draft ITU-T Recommendation and Final Drift International Standard of Joint Video Specification (ITU-T Rec. H.264 ISO/IEC 14496-10 AVC),” document JVT-G050r1, May 2003) (as Well as revisions thereof)(hereinafter the “H.264/AVC standard”). In the interest of clarity, the various devices, systems and processes are described herein in the context the H.264/AVC standard although the present disclosure is not limited to any particular video coding standards and/or specifications. In addition, in accordance with the present disclosure, entropy encoding module 110 may implement a Context-Based Adaptive Arithmetic Coding (CABAC) engine as will be described in greater detail below.

Prediction module 102 may perform spatial and/or temporal prediction using the input video data. For example, input video image frames may be decomposed into slices that are further sub-divided into macroblocks for the purposes of encoding. In a non-limiting example the input video data may be in a 4:2:0 chroma format where each macroblock includes of a 16×16 array of luma samples and two corresponding 8×8 arrays of chroma samples. Other chroma formats such as 4:2:2 (where the two chroma sample arrays are 8×16 in size), and 4:4:4 (having two 16×16 chroma sample arrays), and the like, may also be employed. Prediction module 102 may apply known spatial (intra) prediction techniques and/or known temporal (inter, prediction techniques to predict macroblock data values. Transform module 104 may then apply known transform techniques to the macroblocks to spatially decorrelate the macroblock data. Those of skill in the art may recognize that transform module 104 may first sub-divide 16×16 macroblocks into 4×4 or 8×8 blocks before applying appropriately sized transform matrices. Further, DC coefficients of the transformed data may be subjected to a secondary Hadamard transform.

Quantization module 106 may then quantize the transform coefficients in response to a quantization control parameter that may be changed, for example, on a per-macroblock basis. For example, for 8-bit sample depth the quantization control parameter may have 52 possible values. In addition, the quantization step site may not be linearly related to the quantization control parameter. Scanning module 108 may then scan the matrices of quantized transform coefficients using various known scan order schemes to generate a string of transform coefficient symbol elements. The transform coefficient symbol elements as well as additional syntax elements such as macroblock type, intra prediction modes, motion vectors, reference picture indexes, residual transform coefficients, and so forth may then be provided to entropy encoding module 110.

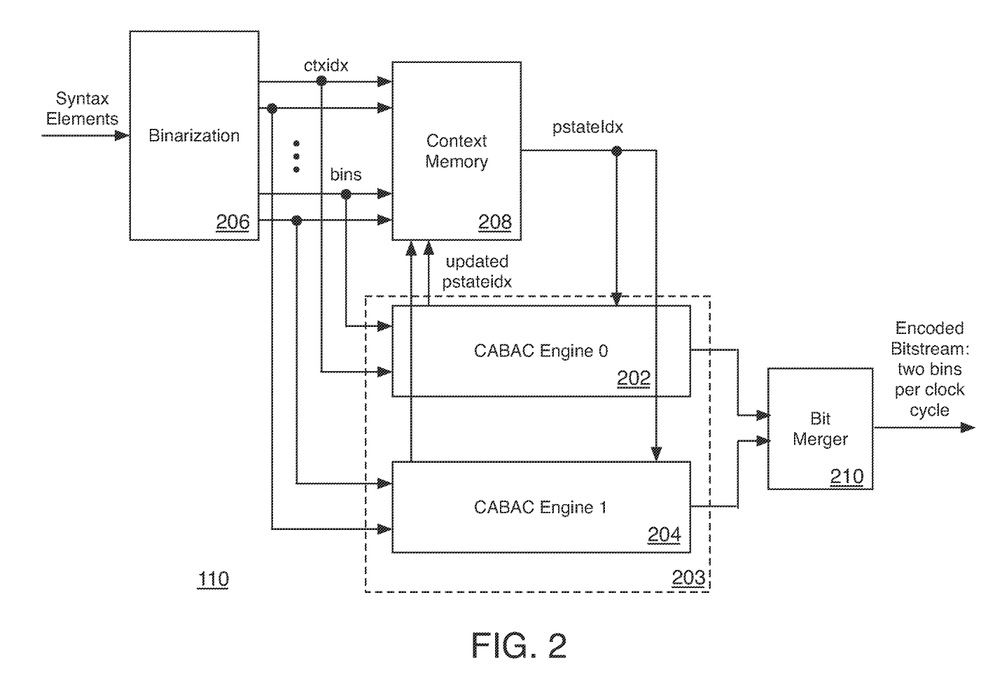

FIG. 2 illustrates entropy encoding module 110 in greater detail in accordance with the present disclosure. Module 110 includes two CABAC engines 202 (CABAC Engine 0) and 204 (CABAC Engine 1), a binarization module 206, a context memory 208 having two read ports and two write ports, and a bit merger module 210. Each non-binary input syntax element (SE) may be processed by binarization module 206 using known binarization techniques (see, e.g., D. Marpe, “Context-Based Adaptive Binary Arithmetic Coding in the H.264/AVC Video Compression Standard,” IEEE Transactions on Circuits and Systems for Video Technology, Vol. 13, No. 7 (July 2003), hereinafter “Marpe”) to generate corresponding SE bits or “bins” (e.g. bin0, Bin1, bin2, . . . , binN). For example, a binary tree structure may be used to binarize SEs that are not already in binary form such as transform coefficient SEs, motion vector SEs, and the like. As those of skill in the art may recognize, the binarization process maps all non-binary valued SEs into bin sequences otherwise known as bin strings. In various implementations, different binarization schemes such as Unary (U), Truncated Unary (TU), kth order Exp-Golomb (EGk), concatenation of the first and third scheme UEGk, and fixed length binarization may be used. Binarization module 206 may also derive a context index (ctxidx) for each bin of an SE. The bin values and their associated context indexes are then provided to context memory 208 as well as to CABAC engines 202 and 204.

As will be explained in greater detail, in accordance with the present disclosure, entropy encoding module 110 may employ CABAC engines 202 and 204 in conjunction with context memory 208 to provide CABAC processing or two bin values during a single clock cycle. To do so, CABAC engines 202 and 204 are communicatively coupled together into a single clock PIPE line 203 such that the internal probability states (pstateidx) of CABAC engines 202 and 204 are stored in context memory 208 and provided to CABAC engines 202 and 204. As will be described in greater detail below, the bin values, the context indexes, and the internal probability states of engines 202 and/or 204 may be used when engines 202 and 204 apply recursive interval subdivision arithmetic coding techniques to the bin values. Bit merger module 210 may then apply known techniques (see, e.g., Marpe) to merge the output of CABAC engines 202 and 204 and generate an encoded bitstream output for coder 100.

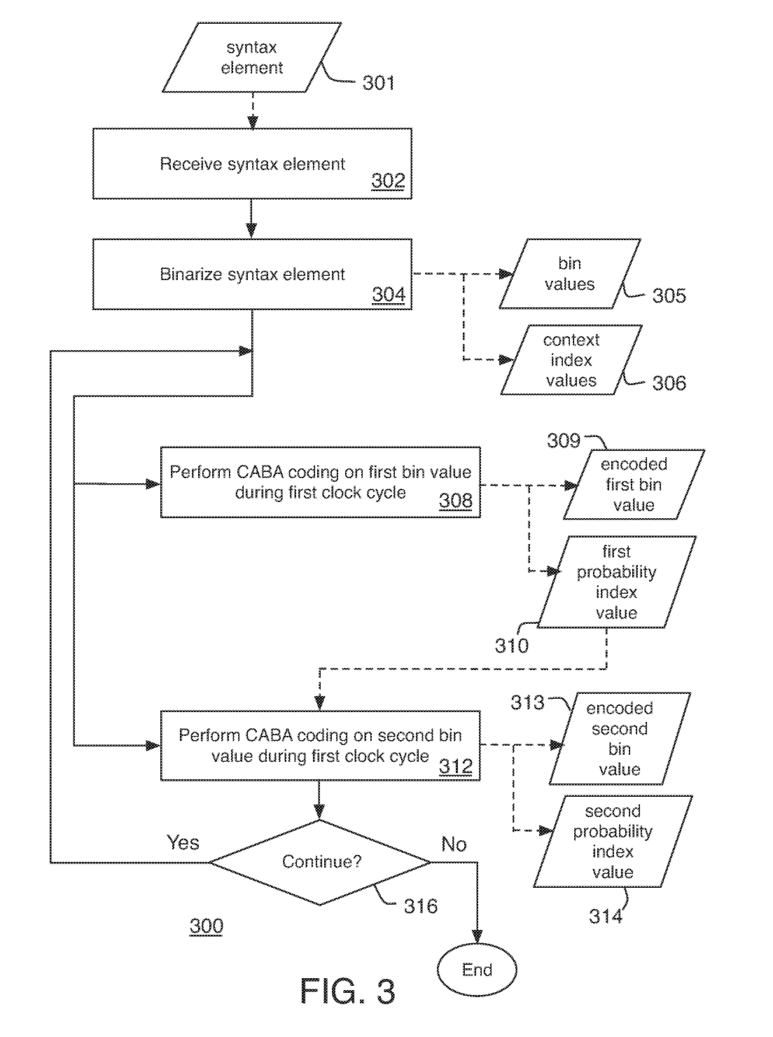

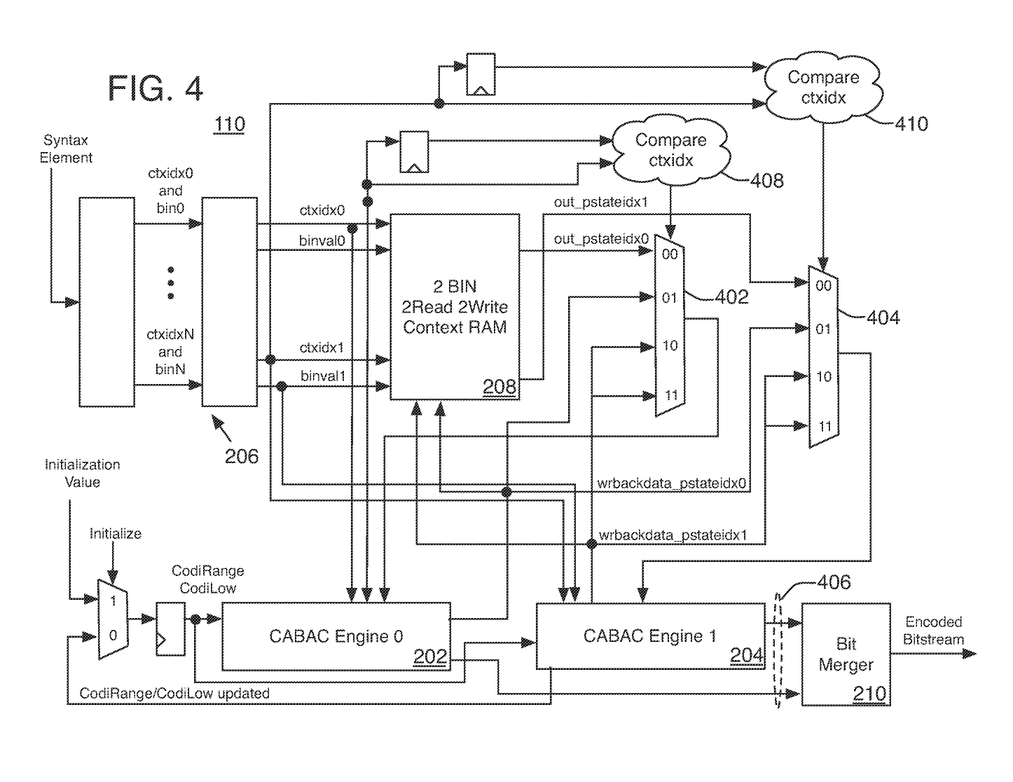

FIG. 3 illustrates a flow diagram of an example process 300 for performing CABAC encoding, of two bin values in a single clock cycle according to various implementations of the present disclosure. Process 300 may include one or more operations, functions or actions as illustrated by one or more of blocks 302, 304, 308, 312 and 316 of FIG. 3. By way of non-limiting example, process 300 will be described herein with reference to example entropy encoder 110 depicted in FIG. 4 in even greater detail in accordance with the present disclosure.

Process 300 may begin at block 302 where a syntax element 301 may be received. For example, an H.264/AVC SE may be received at binarization module 206. As shown in FIG. 4, binarization module 206 may receive an SE including, for example, transform coefficient values, motion vector difference (MVD) values and the like. For example the SE may include the absolute values of each significant transform coefficient.

At block 304 the SE may be binarized to generate multiple bin values 305 and a corresponding number of context index values 306. For example, Table 1 shows example binarization values for different MVD values.

TABLE 1
Example Binarization Values

| \|MVD\| | Binarization value |
|---|---|
| 0 | 0 |
| 1 | 10 |
| 2 | 110 |
| 3 | 1110 |
| 4 | 11110 |
| 5 | 111110 |
| 6 | 1111110 |
| 7 | 11111110 |
| 8 | 111111110 |

For instance, using the example of Table 1, an input M VD SE value of four (4) may be binarized to generate a SE bin string of value 11110, where the first bit of the SE bin string is the first bin of that string, the second bit is the second bin, and so forth. In this particular example, an input MVD SE value of four (4) would be processed by module 206 at block 304 to generate five (5) bins: bin0, bin1, bin2, bin3 and bin4, where each bin has a value of either one (1) or zero (0). In general, for any arbitrary input SE value, module 206 may generate up to N bin values at block 304.

Further, as part of the binarization undertaken at block 304, module 206 may generate context indexes associated with the bins (and hence with the corresponding bin values 305). Those of skill in the art may recognize that under the H.264/AVC standard, each SE may use one of a range of probability models, each of which may be denoted by a context index (e.g., ctxidx0, ctxidx1, . . . , ctxidxN in FIG. 4). Each probability model (uniquely associated with a context index) includes a pair of two values: a 6-bit probability state index and a most probable symbol (MPS) bit value. Thus, each bin's probability model may be represented by a 7-bit context index value 306.

The remainder of the discussion of process 300 will focus on the values of the first two bins (binval0 and binval1) and the respective context index values (ctxidx0 and ctxidx1) of an arbitrary input SE bin string. As shown in FIG. 4, the signals binval0, ctxidx0, binval1, and ctxidx1 are stored in context memory 208, while the binval0 and ctxidx0 signals are provided to CABAC engine 202, and the binval1 and ctxidx1 signals are provided to CABAC engine 204. In general, CABAC engines 202 and 204 may employ two coding modes: regular bin coding which uses context models, and bypass bin coding for bins with equal probability of 0 and 1.

Process 300 may continue at block 308 where, during one clock cycle, Context-Based Adaptive Arithmetic (CABA) coding of a first bin value to generate an encoded first bin value 309 and a first probability state index value 310 may be undertaken. For example, CABAC engine 202 may undertake block 308 by selecting a probability model from a pre-defined set of probability models for binval0 based on context index ctxidx0, where the selected context model indicates a most probable symbol (MPS) and probability state index (pStateIdx) of the bin. Using the selected context model, engine 202 may employ recursive interval subdivision arithmetic coding techniques where a recursive sub-division of interval length may be defined by a low bound (CodiLow) and a length (CodiRange) of the interval.

In various implementations, lock 308 may involve probability estimation using a table-driven estimator where each probability model may take one of 128 different states with, associated probability values, Probabilities for a least probable symbol (ITS) and a most probable symbol (MPS) may be specified and each probability state may be then be specified by the LPS probability value. In various implementations, CABAC engine 202 may also undertake block 308 in response to an initial probability state according to an initial value of a probability state index (out_stateidx0). For CABAC engine 202, block 308 may result in engine 202 providing a probability state index value (wrbackdata_pstateidx0) to context memory 208 and two multiplexers 402 and 404, as well as an encoded bin value 406 to hit merger module 210.

Process 300 may continue at block 312 where, during the same clock cycle in which block 308 is undertaken, CABA coding of a second bin value may he undertaken in response to the first probability state index value 310 to generate an encoded second bin value 313 and a second probability state index value 314. For example, CABAC engine 204 may undertake block 312 by selecting a probability model for binval1 based on context index value ctxidx1 and the value of wrbackdata_pstateidx0 provided by CABAC engine 202. In doing so, CABAC engine 204 may employ recursive interval subdivision arithmetic coding techniques as employed by CABAC engine 202 with respect to block 308. Block 310 may result in engine 204 providing a probability state index value (wrbackdata_pstateidx1) to context memory 208 and multiplexers 402 and 404, as well as an encoded bin value 406 to bit merger module 210.

As those skilled in the art may recognize, arithmetic coding undertaken by CABAC modules 202 and 204 may be based on the principle of recursive interval subdivision where, given a probability estimation p(0) and p(1)−1−p(0) of a binary decision (0,1), an initially given code sub-interval with the range codIRange may be subdivided into two sub-intervals having range p(0)*codIRange and codIRange-p(0)*codIRange, respectively. Depending on the decision, the corresponding sub-interval may be chosen as the new code interval (e.g., as specified by CodiRange/Codilow updated signal in FIG. 4), and a binary code string pointing into that interval may represent the sequence of observed binary decisions. Binary decisions may be identified as either the most probable symbol (MPS) or the least probable symbol (LPS). Thus, each context may be specified by the probability pLPS of the LPS and the value of MPS (valMPS), which is either 0 or 1.

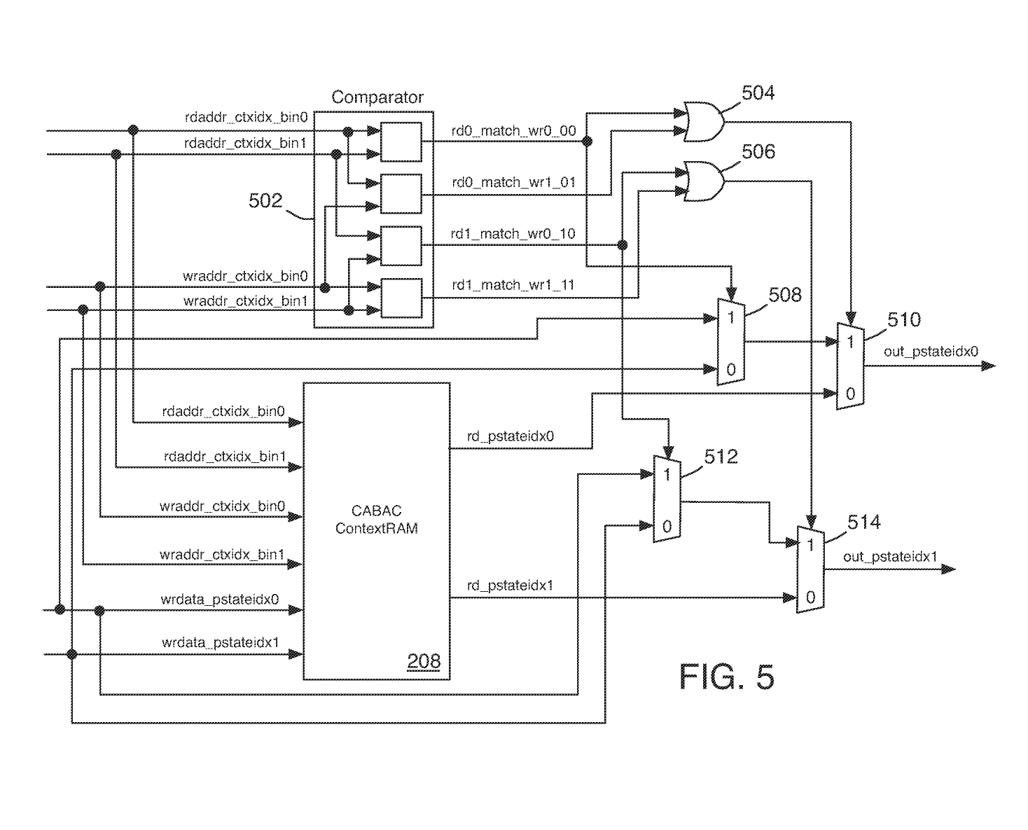

As shown in FIG. 4, using multiplexer 402, context index comparison logic 408 may determine what probability state index is provided to CABAC engine 202 at block 308 and, using multiplexer 404, context index comparison logic 410 may determine what probability state index is provided to CABAC engine 204 at block 312. FIG. 5 illustrates portions of entropy encoder 110 in greater detail in accordance with the present disclosure. In particular, FIG. 5 illustrates read and write operations of the probability state index values depending on the related context index values using a comparator 502, context memory 208, logic gates 504 and 506, and multiplexers 508-514.

Process may continue at block 316 where a decision may be made as to whether to continue with the processing of additional bin values of the SE received at block 302. For example, for SEs having more than two bin values, process 300 may continue by loop back to blocks 308 and 312 where the next two bin values (e.g., binval2 and binval3) and associated context indexes (e.g., ctxidx2 and ctxidx3) may be subjected to CABA coding (as described above) during a subsequent clock cycle. If however, no additional binary values are to be processed then process 300 may end. In various implementations, subsequent iterations of process 300 may be undertaken for remaining non-binary SEs in an SE string.

While implementation of example process 300, as illustrated in FIG. 3, may include the undertaking of all blocks shown in the order illustrated, the present disclosure is not limited in this regard and, in various examples, implementation of process 300 may include the undertaking only a subset of the blocks shown and/or in a different order than illustrated.

In addition, any one or more of the blocks of FIG. 3 may be undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including one or more processor core(s) may undertake one or more of the blocks shown in FIG. 3 in response to instructions conveyed to the processor by a computer readable medium.

As used in any implementation described herein, the term “module” refers to any combination of software, firmware and/or hardware configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

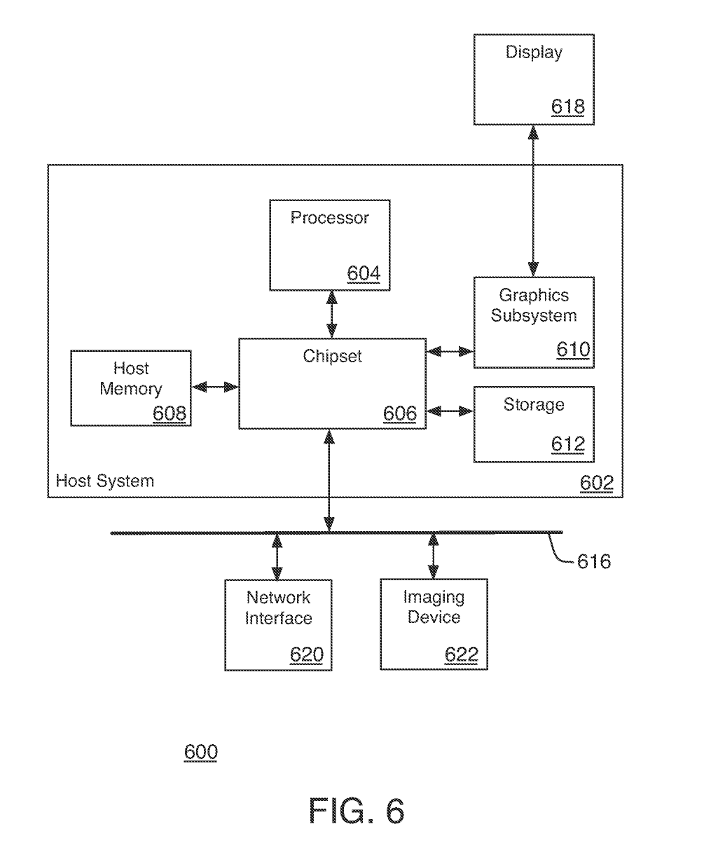

FIG. 6 illustrates an example computing system 600 in accordance with the present disclosure. System 600 may be used to perform some or all of the various functions discussed herein and may include any device or collection of devices capable of undertaking processes described herein in accordance with various implementations of the present disclosure. For example, system 600 may include selected components of a computing platform or device such as a desktop, mobile or tablet computer, a smart phone, a set top box, etc., although the present disclosure is not limited in this regard. In some implementations, system 600 may include a computing platform or SoC based on Intel® architecture (IA) in, for example, a CE device. It will be readily appreciated by one of skill in the art that the implementations described herein can be used with alternative processing systems without departure from the scope of the present disclosure.

Computer system 600 may include a host system 602, a bus 616, a display 618, a network interface 620, and an imaging device 622. Host system 602 may include a processor 604, a chipset 606, host memory 608, a graphics subsystem 610, and storage 612. Processor 604 may include one or more processor cores and may be any type of processor logic capable of executing software instructions and/or processing data signals. In various examples, processor 604 may include Complex Instruction Set Computer (CISC) processor cores, Reduced Instruction Set Computer (RISC) microprocessor cores, Very Long Instruction Word (VLIW) microprocessor cores, and/or any number of processor cores implementing any combination or types of instruction sets. In some implementations, processor 604 may be capable of digital signal processing and/or microcontroller processing.

Processor 604 may include decoder logic that may be used for decoding instructions received by, e.g., chipset 606 and/or a graphics subsystem 610, into control signals and/or microcode entry points. Further, in response to control signals and/or microcode entry points, chipset 606 and/or graphics subsystem 610 may perform corresponding operations. In various implementations, processor 604 may be configured to undertake any of the processes described herein including the example processes described with respect to FIG. 3.

Chipset 506 may provide intercommunication among processor 604, host memory 608, storage 612, graphics subsystem 610, and bus 616. For example, chipset 606 may include a storage adapter (not depicted) capable of providing intercommunication with storage 612. For example, the storage adapter may be capable of communicating with storage 512 in conformance with any of a number of protocols, including, but not limited to, the Small Computer Systems Interface (SCSI). Fibre Channel (FC), and/or Serial Advanced Technology Attachment (S-ATA) protocols. In various implementations, chipset 606 may include logic capable of transferring information within host memory 608, or between network interface 620 and host memory 608, or in general between any set of components in system 600. In various implementations, chipset 606 may include more than one IC.

I-lost memory 608 may be implemented as a volatile memory device such as but not limited to a Random Access Memory (RAM), Dynamic Random Access Memory (DRAM), or Static RAM (SRAM) and so forth. Storage 612 may be implemented as a non-volatile storage device such as but not limited to a magnetic disk drive, optical disk drive, tape drive, an internal storage device, an attached storage device, flash memory, battery backed-up SDRAM (synchronous DRAM), and/or a network accessible storage device or the like.

Memory 608 may store instructions and/or data represented by data signals that may be executed by processor 604 in undertaking any of the processes described herein including the example process described with respect to FIG. 3. For example, host memory 608 may store input images, probability state values, and so forth. In some implementations, storage 612 may also store such items.

Graphics subsystem 610 may perform processing of images such as still or video images for display. For example, in some implementations, graphics subsystem 610 may perform encoding of an input video signal. For example, in some implementations, graphics subsystem 610 may perform activities as described with regard to FIG. 3. An analog or digital interface may be used to communicatively couple graphics subsystem 610 and display 618. For example, the interface may be any of a High-Definition Multimedia Interface, DisplayPort, wireless HDMI, and/or wireless HD compliant techniques. In various implementations, graphics subsystem 610 may be integrated into processor 604 or chipset 606. In some other implementations, graphics subsystem 610 may be a stand-alone card communicatively coupled to chipset 606.

Bus 616 may provide intercommunication among at least host system 602, network interface 620, imaging device 622 as well as other peripheral devices (not depicted) such as a keyboard, mouse, and the like. Bus 616 may support serial or parallel communications. Bus 616 may support node-to-node or node-to-multi-node communications. Bus 616 may at least be compatible with the Peripheral Component Interconnect (PCI) specification described for example at Peripheral Component Interconnect (PCI) Local Bus Specification, Revision 3.0, Feb. 2, 2004 available from the PCI Special Interest Group, Portland, Oregon, U.S.A. (as well as revisions thereof); PCI Express described in The PCI Express Base Specification of the PCI Special Interest Group, Revision 1.0a (as well as revisions thereof); PCI-x described in the PCI-X Specification Rev. 1.1, Mar. 28, 2005, available from the aforesaid PCI Special Interest Group, Portland, Oreg., U.S.A. (as well as revisions thereof); and/or Universal Serial Bus (USB) (and related standards) as well as other interconnection standards.

Network interface 620 may be capable of providing intercommunication between host system 602 and a network in compliance with any applicable protocols such as wired or wireless techniques. For example, network interface 620 may comply with any variety of IEEE communications standards such as 802.3. 802.11, or 802.16. Network interface 620 may intercommunicate with host system 602 using bus 616. In some implementations, network interface 620 may be integrated into chipset 606.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be implemented by a general purpose processor, including a multi-core processor. In a further implementation, the functions may be implemented in a consumer electronics device.

Display 618 may be any type of display device and/or panel. For example, display 618 may be a Liquid Crystal Display (LCD), a Plasma Display Panel (PDP), an Organic Light Emitting Diode (OLED) display, and so forth. In some implementations, display 618 may be a projection display (such as a pico projector display or the like), a micro display, etc. In various implementations, display 618 may be used to display images captured by imaging device 622.

Imaging device 622 may be any type of imaging device capable of capturing video images such as a digital camera, cell phone camera, infra red (IR) camera, and the like. Imaging device 622 may include one or more image sensors (such as a Charge-Coupled Device (CCD) or Complimentary Metal-Oxide Semiconductor (CMOS) image sensor), Imaging device 622 may capture color or monochrome video images. Imaging device 622 may capture video images and provide those images, via bus 616 and chipset 606, to processor 604 for video encoding processing as described herein.

In some implementations, system 600 may communicate with various I/0 devices not shown in FIG. 6 via an I/O bus (also not shown). Such I/O devices may include but are not limited to, for example, a universal asynchronous receiver/transmitter (UART) device, a USB device, an I/O expansion interface or other I/O devices. In various implementations, system 600 may represent at least portions of a system for undertaking mobile, network and/or wireless communications. For example, system 600 may use network interface 620 to communicate an encoded bitstream generated using the systems and processes described herein.

The devices and/or systems described herein, such as example systems or devices of FIGS. 1, 2 and 4-6 represent several of many possible device configurations, architectures or systems in accordance with the present disclosure. Numerous variations of systems such as variations of the example systems described herein are possible consistent with the present disclosure.

The systems described above, and the processing performed by them as described herein, may be implemented in hardware, firmware, or software, or any combination thereof. In addition, any one or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term, software, as used herein, refers to a computer program product including a computer readable medium having computer program logic stored therein to cause a computer system to perform one or more features and/or combinations of features disclosed herein.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

What is claimed:

1. An apparatus, comprising;
a memory;
a first module to entropy encode a first bin value during a first clock cycle in response to a first context index value, wherein the first module is configured to store a first probability state index value in the memory when entropy encoding the first bin value; and
a second module to entropy encode a second bin value during the first clock cycle in response to the second context index value, wherein the second module is configured to store a second probability state index value in the memory when entropy encoding the second bin value.

2. The apparatus of claim 1, further comprising:
a third module to generate the first and second bin values by binarizing a syntax element, to determine the first context index value for the first bin value, and to determine the second context index value for the second bin value.

3. The apparatus of claim 2, wherein the syntax element comprises an H.264/AVC syntax element.

4. The apparatus of claim 1, wherein the memory comprises a context memory having two read ports and two write ports.

5. The apparatus of claim 1, wherein the second module is configured to entropy encode the second bin value in response to the first probability state index value.

6. The apparatus of claim 1, wherein the first module comprises a first Context-Based Adaptive Arithmetic Coding (CABAC) engine, and the second module comprises a second CABAC engine.

7. The apparatus of claim 1, the memory to store the first bin value, the second bin value, the first context index value, and the second context index value.

8. A computer-implemented method, comprising:
performing, during a first clock cycle, Context-Based Adaptive Arithmetic (CABA) coding on a first bin value to generate an encoded first bin value and a first probability slate index vale; and
performing, during the first clock cycle, CABA coding on a second bin Value in response to the first probability state index value to generate an encoded second bin value and a second probability state index value.

9. The method of claim 8, wherein performing CABA, coding on the first bin value comprises:
performing recursive interval subdivision arithmetic coding in response to a first context index value and the first bin value to generate the encoded first bin value and the first probability state index value; and
storing the first probability state index value in memory,

10. The method of claim 9, wherein the memory comprises a context memory having two read ports and two write ports.

11. The method of claim 9, wherein performing CABA coding on the second bit value comprises:
performing recursive interval subdivision arithmetic coding in response to a second context index value and the second bin value to generate the encoded second bin value and the second probability state index value; and
storing the second probability state index value in the memory.

12. The method of claim 8, wherein performing CABA coding on the first bin value comprises using a first CABAC engine to perform CABA coding on the first bin value, and wherein performing CABA coding on the second bin value comprises using a second CABAC engine to perform CABA coding on the second bin value.

13. The method of claim 8, further comprising:
receiving a syntax element; and
binarizing the syntax element to generate the first bin value and the second bin value.

14. The method of claim 13, wherein the syntax element comprises an H.264/AVC syntax element.

15. A system, comprising:
an imaging device: and
a computing system, wherein the computing system is communicatively coupled to the imaging device and wherein the computing system is to:
perform, during a first clock cycle, Context-Based Adaptive Arithmetic (CABA) coding on a first bin value to generate an encoded first bin value and a first probability state index value; and
perform, during the first clock cycle CABA coding on a second bin value in response to the first probability state index value to generate an encoded second bin value and a second probability state index value.

16. The system of claim 15, wherein to perform CABA coding on the first bin value the computing system is to:
perform recursive interval subdivision arithmetic coding in response to a first context index value and the first bin value to generate the encoded first bin value and the first probability state index value; and
store the first probability state index value in a context memory.

17. The system of claim 16, wherein the context memory includes two read ports and two write ports.

18. The system of claim 16, wherein to perform CABA coding on the second bin value the computing system is to:
perform recursive interval subdivision arithmetic coding in response to a second context index value and the second bin value to generate the encoded second bin value and the second probability state index value; and
store the second probability state index value in the context memory.

19. The system of claim 15, wherein to perform CABA coding on the first bin value the computing system is to use a first CABAC engine to perform CABA coding on the first bin value, and wherein to perform CABA coding on the second bin value the computing system is to use a second CABAC engine to perform CABA coding on the second bin value.

20. The system of claim 15, wherein the computing system is to:
binarize a syntax element to generate the first bin value and the second bin value.

21. The system of claim 20, wherein the computing system is to:
receive video content from the imaging device; and
process the video content to generate the syntax element.

22. The system of claim 20, wherein the syntax element comprises an H.264/AVC syntax element.

23. An article comprising a computer program product having stored therein instructions that, if executed, result in:
performing, during a first clock cycle, Context-Based Adaptive Arithmetic (CABA) coding on a first bin value to generate an encoded first bin value and a first probability state index value: and
performing, during the first clock cycle, CABA coding on a second bin value in response to the first probability state index value to generate an encoded second bin value and a second probability state index value.

24. The article of claim 23, wherein performing CABA coding on the first bin value comprises:
performing recursive interval subdivision arithmetic coding in response to a first context index value and the first bin value to generate the encoded first bin value and the first probability state index value; and
storing the first probability state index value in memory.

25. The article of claim 24, wherein the memory comprises a context memory having two read ports and two write ports.

26. The article of claim 24, wherein performing CABA coding on the second bin value comprises:
performing recursive interval subdivision arithmetic coding in response to a second context index value and the second bin value to generate the encoded second bin value and the second probability state index value; and
storing the second probability state index value in the memory.

27. The article of claim 23, wherein performing CABA coding on the first bin value comprises using a first CABAC engine to perform CABA coding on the first bin value, and wherein performing CABA coding on the second bin value comprises using a second CABAC engine to perform CARA coding on the second bin value.

28. The article of claim 23, having stored therein further instructions that, if executed, result in:
receiving a syntax element; and
binarizing the syntax element to generate the first bin value and the second bin value.

29. The article of claim 28, wherein the syntax element comprises an H.264/AVC syntax element.
